(19) United States
(12) Patent Application Publication
(10) Pub. No.: US 2011/0016177 A1
(43) Pub. Date: Jan. 20, 2011

(54) THIN CLIENT SYSTEM AND THIN CLIENT SYSTEM CONTROLLING METHOD

(76) Inventor: Hiroyuki Tomimori, Tokyo (JP)

Correspondence Address: Mr. Jackson Chen, 6535 N. STATE HWY 161, IRVING, TX, 75039, US

(21) Appl. No.: 12/922,305

(22) PCT Filed: Mar. 27, 2009
(86) PCT No.: PCT/JP2009/001402

§ 371 Date: Sep. 13, 2010

(30) Foreign Application Priority Data
Mar. 27, 2008 (JP) 2008-085042

(51) Int. Cl. G06F 15/16

(52) U.S. Cl. 709/203

(57) ABSTRACT

A thin client system in which a client execution system and a screen transfer system can be changed dynamically from one to the other while executing an application and the application can be executed beyond the functional restriction of a client terminal and a server apparatus is provided. Using the thin client system comprising the client terminal and the server apparatus, an input/an output between the client terminal and the server apparatus by the application started on the thin client system are controlled according to previously regulated policy information.

### TECHNICAL FIELD

The present invention relates to a distributed processing technology of an application, in particular to a thin client system and a thin client system controlling method, in which two systems of a client execution system executing the application on a client terminal and a screen transfer system executing the application on a server and transferring a screen output therefrom to the client terminal can be changed dynamically.

### BACKGROUND ART

All of patents, patent applications, patent publications, scientific articles and the like, which will hereinafter be cited or identified in the present application, will hereby be incorporated by references in their entirety in order to describe more fully the state of the art, to which the present invention pertains.

As an application execution system in the thin client system, it is known that the client execution system in which the client terminal downloads an application located on the server apparatus as needed and executes the application and, the screen transfer system in which the server apparatus executes the application and transmits the screen output to the client terminal and the screen output is displayed. In the screen transfer system, an operability such as the application would be executed on the client terminal is achieved by transmitting input information by a keyboard and mouse and the like by the client terminal to the application on the server apparatus.

For example, the client execution system is described in the patent documents 1 and 2, the screen transfer system is described in the patent documents 3 and 4.

Patent document 1: JP-A-2004-234345

Patent document 2: JP-A-2006-323660

Patent document 3: JP-A-2007-102308

Patent document 4: JP-A-2007-310508

### DISCLOSURE OF THE INVENTION

### Problems to be Solved by the Invention

A first problem is that an execution system of the application cannot be changed while executing the application in a conventional thin client system described in the patent documents 1 and 2. This is because a method for dynamically changing the client execution system which is and the screen transfer system is not considered at all. A second problem is that execution of the application is restricted within functions of the client terminal in the client execution system. This is because a function call from the application is performed to the client terminal. A third problem is that execution of the application is restricted within functions of the server apparatus in the screen transfer system described in the patent documents 3 and 4. This is because a function call from the application is performed to the server apparatus.

In view of above, the purpose of the present invention is to provide a thin client system in which a client execution system and a screen transfer system can be changed dynamically from one to the other while executing an application and, the application can be executed beyond the functional restriction of a client terminal and a server apparatus.

### Means to Solve the Problems

To solve the problems described above, a thin client system controlling method of the present invention controls, using a thin client system comprising a client terminal and a server apparatus, an application execution system between the client terminal and the server apparatus according to policy information in which application execution policy for executing applications which are started up on the thin client system is described. In input/output control policy information, it is previously described how to process an input/output of the application executed in a client execution system and a screen execution system. The application is made to execute on the client terminal and the server apparatus and, an input and an output of each application are controlled according to input/output control policy information which corresponds to present execution system. In a case of occurring a change request of execution system, controlling the input/output of both applications according to the input/output control policy information which corresponds to execution form after changing makes it possible to dynamically change the execution system of the application and to execute application beyond the functional restriction of the terminal.

Here, as a terminal, a computer terminal which is a thin client terminal can be applied, in addition, a mobile computer such as a cellular phone terminal and a PDA can be applied.

In such case, as an input/output device, a keyboard, a mouse, communication and input/output of a file can be applied, in addition, functions which are not loaded on a server such as GPS function on a cellular phone, music play function and camera function can be applied.

A thin client system of the present invention comprises a client terminal and a server apparatus wherein

policy information, in which application execution policy for executing applications each of which is started up on the thin client system is described, is stored.

### EFFECT OF THE INVENTION

A first advantage is that it is possible to change, while executing the application, from the client execution system to the screen transfer system and from the screen transfer system to the client execution system. This is because the applications are previously executed on the client terminal and the server apparatus and, the input/output of each to application is controlled according to input/output control policy information thereby, allowing states of the both applications to change execution system dynamically. A second advantage is that it is possible to execute the application without restriction by the functions of the client terminal in the client execution system. This is because a part of functions of the application can be executed on the server apparatus according to the input/output control policy information. A third advantage is that it is possible to execute the application without restriction by the functions of the server apparatus in the screen transfer system. This is because a part of functions of the application can be executed on the client terminal according to the input/output control policy information.

### BRIEF DESCRIPTION OF THE DRAWINGS

FIG. 1 is a block diagram of a client terminal of a thin client system for explaining a first embodiment of the present invention.

FIG. 2 is a block diagram of a server apparatus of a thin client system for explaining a first embodiment of the present invention.

FIG. 3 is a conceptual flowchart of a thin client system controlling method in a thin client system for explaining a first embodiment of the present invention.

FIG. 4 is a flowchart of a client execution system in a thin client system controlling method for a thin client system for explaining a first embodiment of the present invention.

FIG. 5 is a flowchart of input/output control in a client execution system in a thin client system controlling method for a thin client system for explaining a first embodiment of the present invention.

FIG. 6 is a flowchart of system change in a thin client system controlling method for a thin client system for explaining a first embodiment of the present invention.

FIG. 7 is a flowchart of a screen transfer system in a thin client-system controlling method for a thin client system for explaining a first embodiment of the present invention.

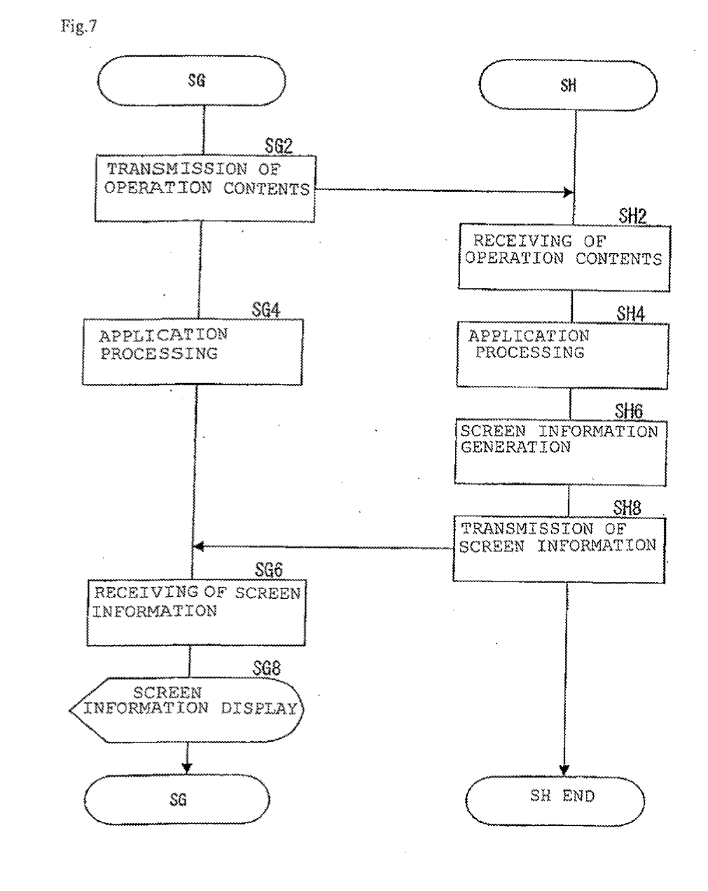

FIG. 8 is a block diagram of a client terminal of a thin client system for explaining a second embodiment of the present invention.

FIG. 9 is a flowchart of a thin client system controlling method in a thin client system for explaining a second embodiment of the present invention.

FIG. 10 is a block diagram of a client terminal of a thin client system for explaining a third embodiment of the present invention.

FIG. 11 is a flowchart of a thin client system controlling method in a thin client system for explaining a third embodiment of the present invention.

### EXPLANATIONS OF SYMBOLS

100 client terminal
101 application execution control device
102 input/output detection control device
103 file input/output device
104 communication device
105 input device
106 display device
200 server apparatus
201 application execution control device
202 input/output detection control device
203 file input/output device
204 communication device
205 application/input-output control policy storage section
208 storage detection device
210 buttery capacity detection device

### PREFERRED MODES FOR CARRYING OUT THE INVENTION

The following describes embodiments of the present invention by way of a plurality of examples.

### First Embodiment

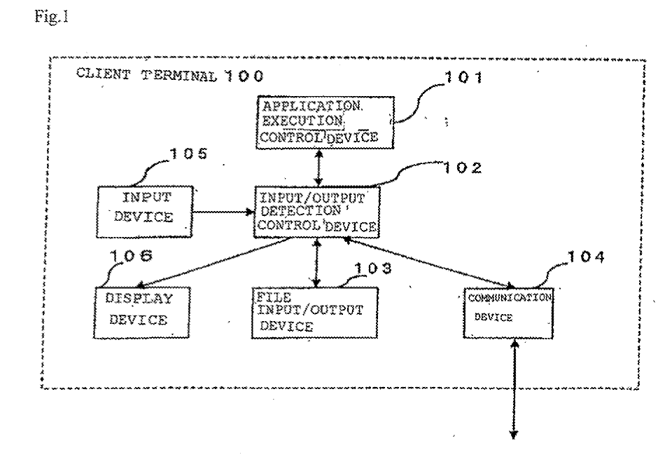

The embodiment of the present invention comprises a client terminal and a server apparatus, both of which are connected through a network. Referring to FIG. 1, the client terminal 100 has an application execution control device 101 controlling a download of an application and execution thereof, an input/output detection control device 102 detecting an input/output of the application and performing a control according to policy information, a file input/output device 103 loading and writing to a file, a communication device 104 performing network communication with the server apparatus and other computer and the like, an input device 105 such as a keyboard and a mouse and, a display device 106 such as a display. Here, it is preferred that an application executed on the server apparatus and an application executed on the client terminal 100 are identical and same version and, API functions of the applications are identical and compliant OSs are identical. In a case where the compliant OSs are different, the application may be executed on a virtual machine based on an identical OS.

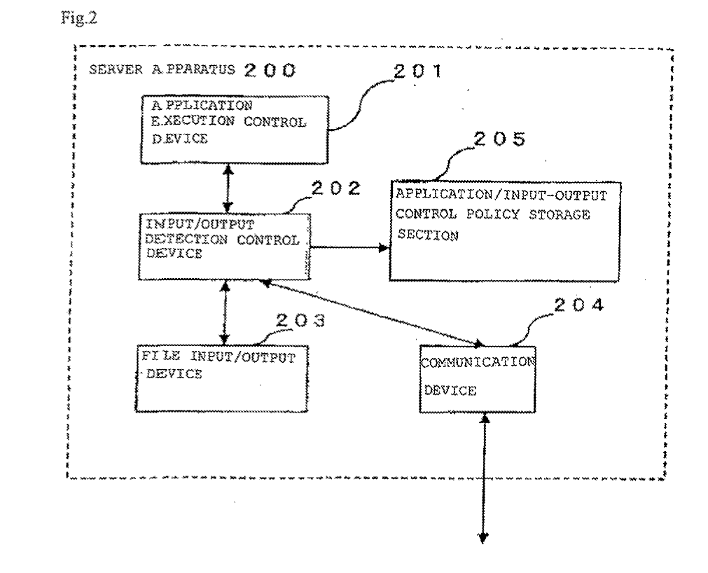

Referring to FIG. 2, the server apparatus 200 has an application execution control device 201 controlling a download of the application to client terminal and execution of the application executed on the server apparatus, an input/output detection control device 202 having functions similar to that of the client terminal, a file input/output device 203, a communication device 204 and an application/input-output control policy storage section 205 storing the application and input/output control policy information in which an application execution policy for executing the application defining input/output method of the application.

TABLE 1
client execution system input/output control policy

| | |
|---|---|
| client application | server application |

| input/output event | input | output | input | output |
|---|---|---|---|---|
| keyboard, mouse | client | — | client | — |
| communication | client | client | client | No |
| file | client | client | server | server |
| . . . | | | | |

TABLE 2
screen transfer system input/output control policy

| | |
|---|---|
| client application | server application |

| input/output event | input | output | input | output |
|---|---|---|---|---|
| screen | — | server | — | server |
| keyboard, mouse | client | — | client | — |
| communication | server | no | server | server |
| file | client | client | server | server |
| . . . | | | | |

The input/output control policy information includes, with reference to the table 1 and the table 2, a policy information applied in a case of executing the application in the client system and, a policy information applied in a case of execution in the screen transfer system. In each policy information, it is described how to process input/output events, which are occurred by various input/output devices such as the keyboard, the mouse, the communication and the files in each application executed on the client and the server. For example, the policy information shown in the table 1 means that, when communication event is occurred to the application executed on the client terminal (hereinafter referred to as the client appli) in the client execution system, both of an input and an output are processed on the client terminal side and, as a communication input to the application executed on the server apparatus (hereinafter referred to as the server appli) at the same timing, a communication input to the application on the client terminal is used and, no output. Next, an operation of preferred mode for carrying out the present invention will be described below.

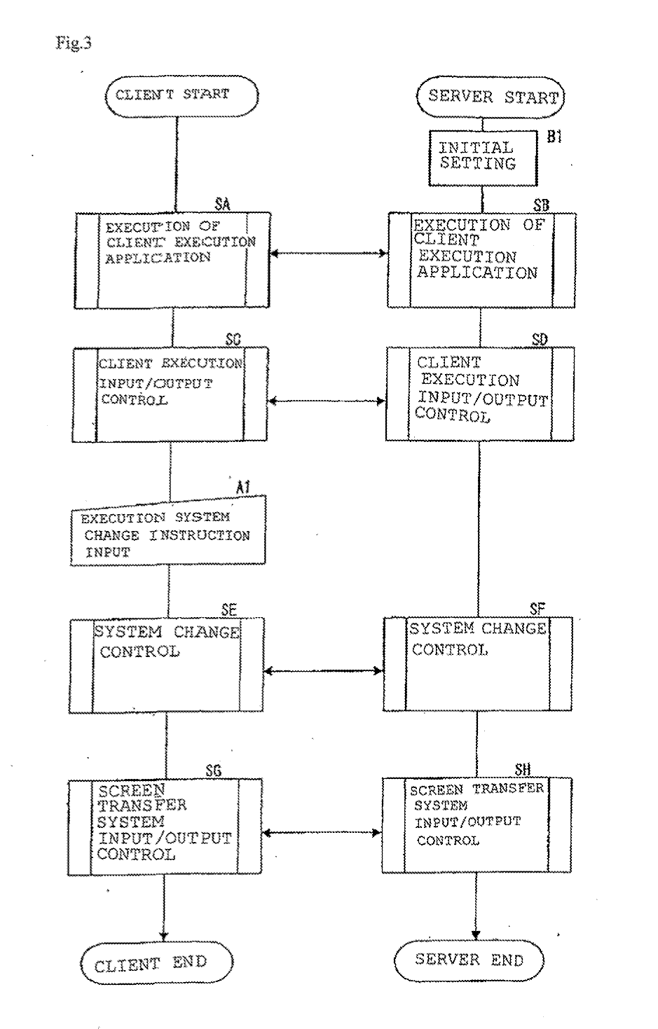

At first, the embodiment will be described using FIG. 1, FIG. 2 and FIG. 3. FIG. 3 shows a flowchart of execution system change by changing policy information on the thin client controlling method by the thin client system of the present invention. Flow of the client terminal 100 is shown on left side and flow of the server apparatus 200 is shown on right side.

The input/output control policy information shown in the table 1 and table 2 is previously stored in the application/input-output control policy storage section 205 of the server apparatus 200 (step B1).

First, in a case where the client execution system are selected, the client terminal 100 executes a client execution application while communicating with the server apparatus 200 (routine SA), further, begins a client execution input/output control (step SC). The server apparatus 200 also executes the client execution application (routine SB), further begins the client execution input/output control (step SD).

Here, an execution system change instruction is inputted by the input device 105 of the client terminal 100 (step A1).

Then, the client terminal 100 executes a system change control (routine SE) while communicating with the server apparatus 200, next, a screen transfer system input/output control is executed (routine SG). In similar way, the server apparatus 200 executes the system change control (routine SF), then, the screen transfer system input/output control is executed (routine SH).

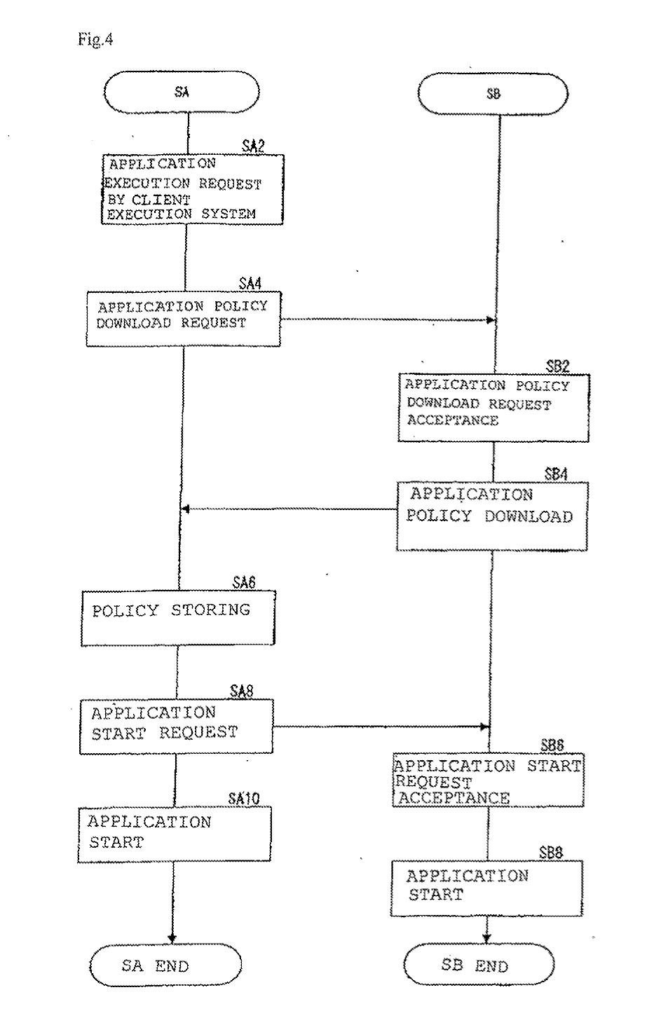

Next, using FIG. 4, operations of the client terminal and the server apparatus in a case of executing the application in client execution system, that is, the routines SA and SB, are described in detail.

In the routine SA, when a user who operates the client terminal 100 requests an application execution in client system via the input device 105 (step SA2), the request is notified of the application execution control device 101 through the input/output detection control device 102. When the application execution control device 101 receives the request, the application execution control device 101 requests a download of the application and the input/output control policy information to the server apparatus 200 to the communication device 104 via the input/output detection control device 102 (step SA4).

In the routine SB, the application execution control device 201 of the server apparatus 200 receives a download request from the client terminal 100 via the communication device 204 and the input/output detection control device 202 (step SB2) and, transmits the application and the policy information stored in the application/input-output control policy storage section to the client terminal 100 (step SB4).

The input/output detection control device 102 of the client terminal 100 receives the application and the policy information via the communication device 104, stores the policy information to the file input/output device (step SA6), after that, transmits the application to the application execution control device 101. The application execution control device 101 requests a start of the application to the server apparatus 200 (step SA8), after that, starts up the application (step SA10).

The application execution control device 201 of the server apparatus 200 receives an application start request from the client terminal 100 (step SB6) and, loads the application from the application/input-output control policy storage section and starts execution of the application (step SB8).

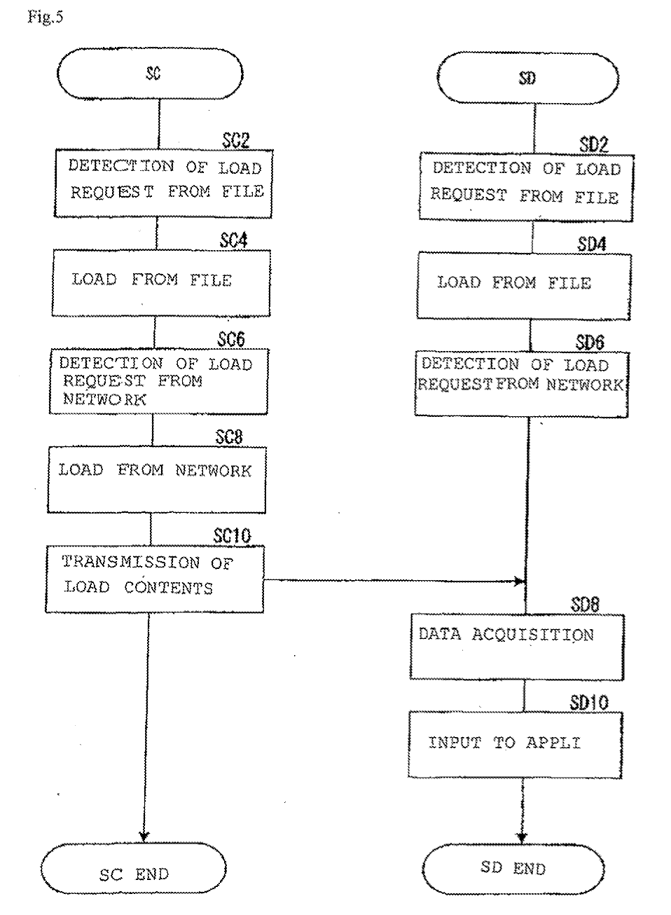

Next, using FIGS. 1, 2 and 5 and tables 1 and 2, a method for controlling an input and an output of each application according to the input/output control policy information while executing the application on the client terminal 100 and the server apparatus 200, that is, the routines SC and SD, are described. In routine SC, when the client appli executed on the client terminal 100 tries to load from the file, the input/output detection control device 102 detects it (step SC2). The input/output detection control device 102 refers to the input/output control policy information shown in table 1 and requests a load of the file to the file input/output device 103 according to the policy information showing a policy that the client appli performs a file load to the client terminal 100 and the server appli performs the file load to the server apparatus 200 (step SC4). Here, two type of method for loading the input/output control policy information are existed. A first method is hooking API function by a system call in OS and performing an input/output according to the policy information to return the function. In this case, since a processing is performed on OS side, it can adopt without any change for application software and it is easy to implement.

On the other hand, the second method is generating functions which are API functions relating to each input/output and further having policy loading function. In this case, in source code of corresponding application, because API functions relating to input/output are replaced to the functions having policy loading function, it is needed to change an application but it is possible to minimize a change on OS.

Moreover, although it is described about the API function on OS above, it is not limited to OS if it is the API function, it can apply to API in application and API of middleware. For example, it can apply to Android (trademark), Moap (trademark) which is OS for a cellular phone, JAVA (registered trademark) which is program language, IE API (trademark) of Internet Explorer which is an application, WINDOWS (registered trademark) API (trademark) which is API of OS, UNIX (registered trademark) API (trademark) and LINUX API (trademark). Moreover, as a middleware, it can apply to a virtual machine. In similar at the server apparatus 200, in routine SD, the input/output detection control device 202 detects loading a file (step SD2) and, executes loading a file from the file input/output device 203 according to the description of the policy information (step SD4). Then, the input/output detection control device 102 detects a load request of data from the network (step SC6) and, loads data from the communication device 104 to transmit it to the client appli (step SC8) and, transmits load data to the server apparatus 200 (step SC10). The input/output detection control device of the server apparatus 200, when the server appli detects the load request of data from the network (step SD6), waits for receiving data from the client terminal 100 according to the policy information and, when receiving data (step SD8), returns the data to the server appli (step SD10).

After that, for each detecting the input/output request from the application by the input/output detection control device 102 and the input/output detection control device 202, the input/output control is performed according to the policy information in the similar way described above.

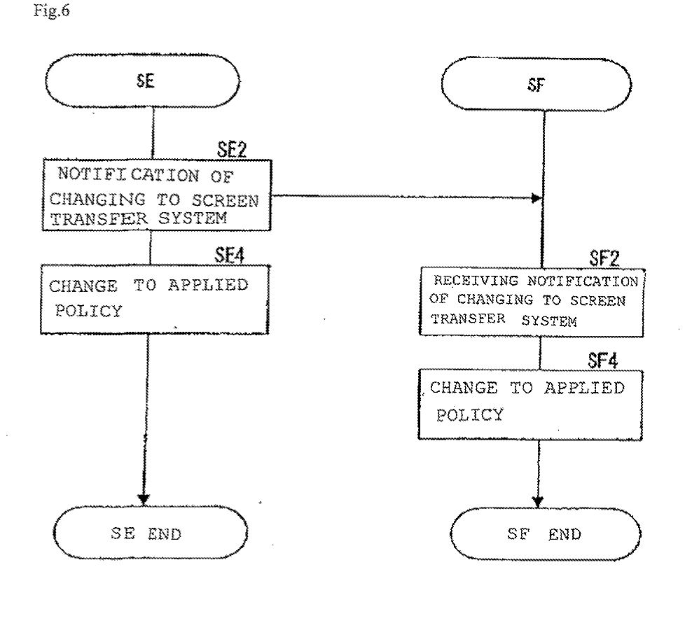

Next, as shown in FIG. 6, when the user inputs to the input device 105 such that an application execution system is to be changed to the screen transfer system, in the routine SE, the input/output detection control device 102 transmits a request to the input/output detection control device 202 of the server apparatus 200 (step SE2), after that, changes the policy information to be referred after detecting the input/output request to policy information of the screen transfer system shown in table 2 (step SE4). When the input/output detection control device 202 receives changing notification to the screen transfer system as shown in the routine SF (step SF2), the input/output detection control device changes an applied policy information in a similar way (step SF4). After that, the input/output detection control device 102 and the input/output detection control device 202 repeat the input/output control according to the policy information changed, for each detecting the input/output request from the application.

Further, upon changing the screen transfer system, as the routine SG, operation contents of the client terminal 100 are transmitted to the server apparatus 200 (SG2), then, in the routine SH, operation contents by the input device such as the keyboard are received (SH2). In the client terminal 100, an application processing is performed but, any screen is not generated (SG4). The server apparatus 200 executes the application and performs the application processing (SH4). Further, the server apparatus generates screen information by the result of the application processing (SH6). The transmission of the screen information is shown in (SH8), the communication device receives the screen information and the input/output detection control device 102 displays the screen information on the screen information display section SG8.

### Second Embodiment

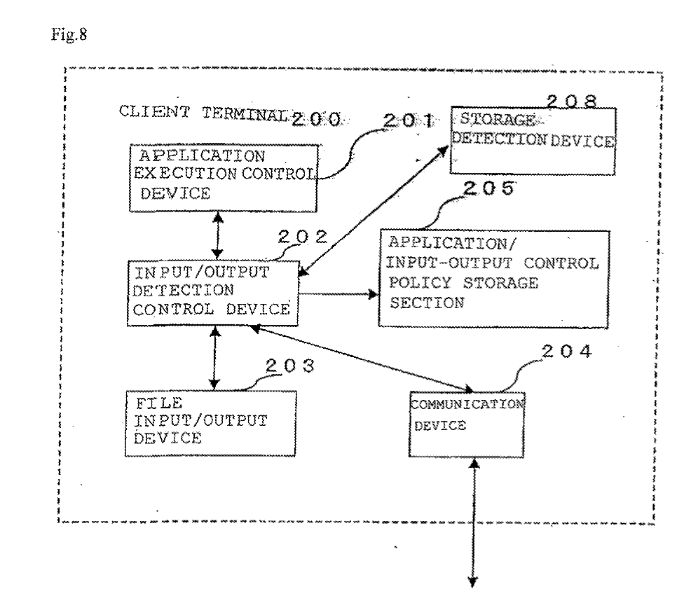

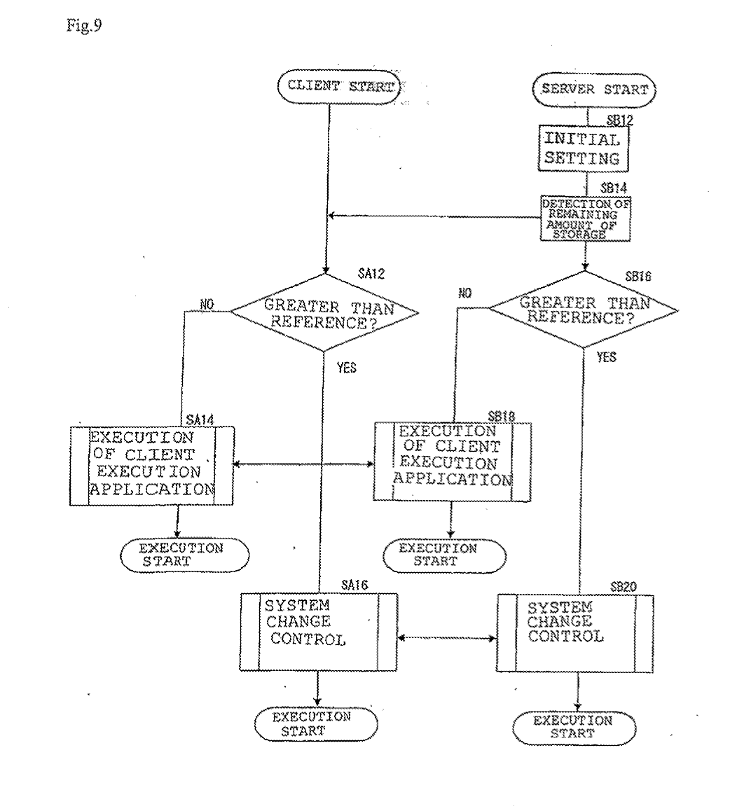

Next, the second embodiment of the present invention will be described using FIG. 8 and FIG. 9.

FIG. 8 shows a block diagram of the client terminal 200 of the thin client system for explaining the second embodiment of the present invention and, FIG. 9 shows a flowchart of the thin client system controlling method in the thin client system for explaining the second embodiment of the present invention.

A difference between FIG. 8 and FIG. 2 is that a storage detection device 208 is connected to the input/output detection control device 202. The storage detection device 208 is a device to detect a remaining amount of storage of the client terminal 100. For example, it is a device to detect whether or not the remaining amount of the storage of the client terminal 100 falls below a predetermined value.

In FIG. 9, the application and the input/output control policy information shown in tables 1 and 2 are previously stored in the application/input-output control policy storage section 205 of the server apparatus 200 (step SB12).

Then, the storage detection device 208 detects the amount of storage of the client terminal 100. If a vacant storage of the client terminal 100 exceeds 100 kB, the client execution is permitted (routine SA14). Therefore, it starts a server application execution routine SA18 which is identical application with the client. At this time, it starts an execution routine of client execution application SB18 at the server apparatus 200. Here, the routines SAI4 and SA 18 correspond to SA and SB in the first embodiment and, following SC and SD.

On the other hand, if the vacant storage of the client terminal 100 falls below 100 kB, the client execution is not permitted (routine SA16). Both of the client terminal 100 and the server apparatus 200 start the system change control SA16 and SB 20. Here, the routines SA 16 and SA20 correspond to SE and SF in the first embodiment and, following SG and SH.

### Third Embodiment

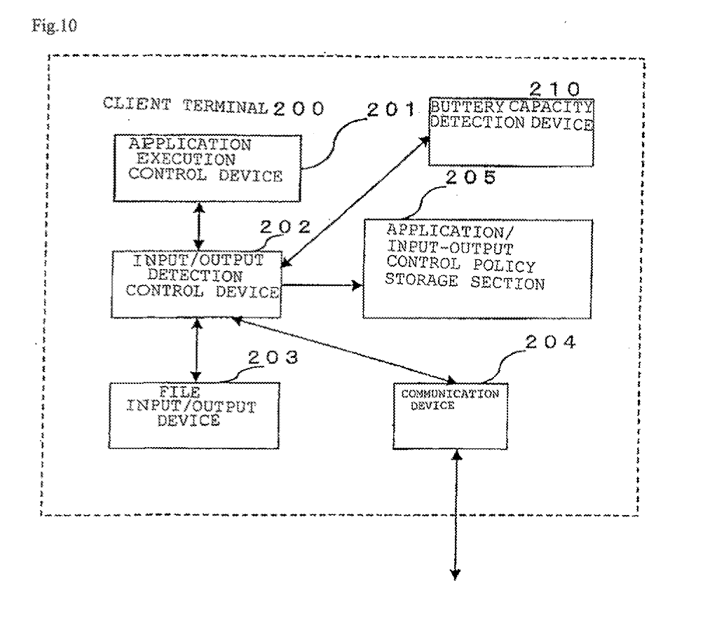

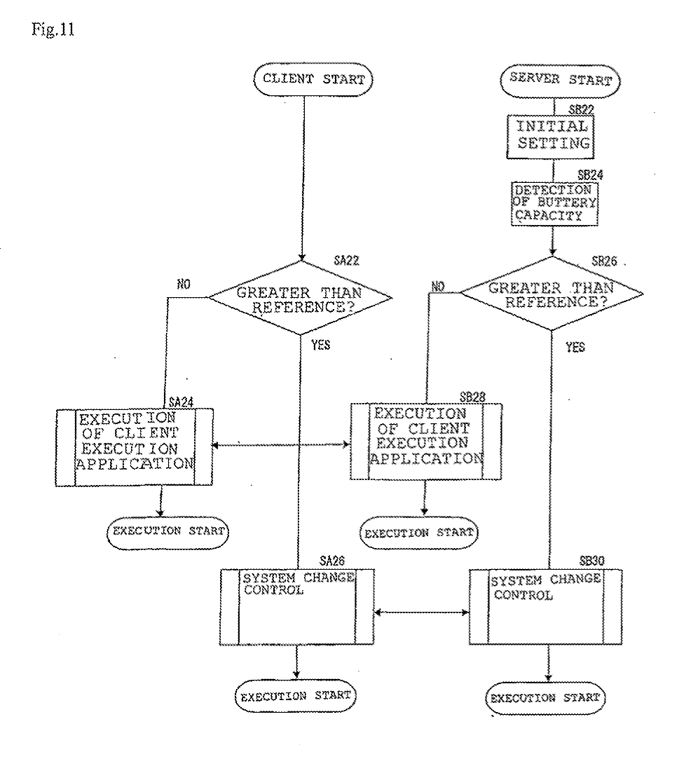

Next, the third embodiment of the present invention will be described using FIG. 10 and FIG. 11.

FIG. 10 shows a block diagram of the client terminal 200 of the thin client system for explaining the third embodiment of the present invention and, FIG. 11 shows flowchart of the thin client system controlling method in the thin client system for explaining the third embodiment of the present invention.

A difference between FIG. 10 and FIG. 2 is that a buttery capacity detection device 210 is connected to the input/output detection control device 202. The buttery capacity detection device 210 is a device to detect a buttery capacity of the client terminal 100. For example, it is a device to detect whether or not a remaining amount of buttery charge of the client terminal 100 falls below a predetermined value.

In FIG. 11, the application and the input/output control policy information shown in tables 1 and 2 are previously stored in the application/input-output control policy storage section 205 of the server apparatus 200 (step SB22).

Then, the buttery capacity detection device 210 detects the buttery capacity of the client terminal 100. If the buttery capacity of the client terminal 100 exceeds one third of full charge, the client execution is permitted (routine SA22). Therefore, it starts an execution routine of client execution application SB24. At this time, the server apparatus 200 starts a server application execution routine SA18 which is identical with the client application. Here, the routines SA24 and SA28 correspond to SA and SB in the first embodiment and, following SC and SD.

On the other hand, if the buttery capacity of the client terminal 100 falls below one third of full charge, the client execution is not permitted (routine SA22). Both of the client terminal 100 and the server apparatus 200 start the system change control SA26 and SB 30. Here, the routines SA26 and SA30 correspond to SE and SF in the first embodiment and, following. SG and SH.

### Other Embodiment of the Present Invention

Referring to the input/output control policy information shown in tables 1 and 2, types of events are described as input/output events, otherwise, it is possible to describe a specific file name and communication destination host name (or IP address) and, to control the input/output for each file and for each communication destination host. In this case, in the step SC2 and the step SC6, the input/output detection control device 102 may check file or host to which an input/output request to file or communication from the application is transmitted, after that, may execute a control according to the policy information.

### INDUSTRIAL APPLICABILITY

The present invention can apply anything and is not limited on possibility for use, if the present invention relates to a distributed processing technology of an application, in particular to a thin client system and a thin client system controlling method, in which two systems of a client execution system executing the application on a client terminal and a screen transfer system executing the application on a server and transferring a screen output therefrom to the client terminal can be changed dynamically.

While the present invention has been described by associating with some preferred embodiments and examples, it is to be understood that these embodiments and examples are merely for illustrative of the invention by an example, and not restrictive. While it will be obvious to those skilled in the art that various changes and substitutions by equivalent components and techniques are eased upon reading the specification, it is believed obvious that such changes and substitutions fit into the true scope and spirit.

1. A thin client system controlling method controlling, using a thin client system comprising a client terminal and a server apparatus, an application execution system between the client terminal and the server apparatus according to policy information in which application execution policy for executing applications each of which is started up on the thin client system is described.

2. The thin client system controlling method according to claim 1 wherein, in the policy information, the application execution policy for executing a client application and a server application loaded on the server apparatus and being identical to the client application is described for a client execution system and a screen transfer system.

3. The thin client system controlling method according to claim 2 including:
a step in which the thin client system starts up the client application and the server application in either the client execution system or the screen transfer system and controls applications according to the policy information which is the application execution policy for executing each application; and
a step in which the thin client system receives a change request to other execution system while executing application then, controls execution according to the policy information of the other execution system.

4. The thin client system controlling method according to claim 1 wherein, in the policy information, the application execution policy for executing application is described for an input and an output of the application.

5. The thin client system controlling method according to claim 1 wherein, in the policy information, control method is described for event types of input/output of the application.

6. The thin client system controlling method according to claim 1 wherein, a change of execution system is achieved by changing the policy information applied.

7. The thin client system controlling method according to claim 1 wherein, various conditions can be described as event types of input/output control policy information.

8. A thin client system comprising a client terminal and a server apparatus wherein
policy information, in which application execution policy for executing applications each of which is started up on the thin client system is described, is stored.

9. The thin client system according to claim 8 wherein, in the policy information, the application execution policy for executing the application is described for a client execution system and a screen transfer system.

10. The thin client system according to claim 9 wherein the thin client system:
starts up a client application and a server application loaded on the server apparatus and being identical to the client application in either the client execution system or the screen transfer system and, controls applications according to the policy information which is the application execution policy for executing each application; and,
receives a change request to other execution system while executing application then, controls execution according to the policy information of the other execution system.

11. The thin client system according to claim 8 wherein, in the policy information, controlling method is described for an input and an output of the application.

12. The thin client system according to claim 8 wherein, in the policy information, control method is described for event types of input/output of the application.

13. The thin client system according to claim 8 wherein, a change of execution system is achieved by changing the policy information applied.

14. The thin client system according to claim 8 wherein, various conditions can be described as event types of input/output control policy information.

15. A client terminal using a thin client system comprising the client terminal and a server apparatus and, storing policy information in which application execution policy for executing application which is started up on the thin client system is described.

16. A server apparatus using a thin client system comprising a client terminal and the server apparatus and, storing policy information in which application execution policy for executing application which is started up on the thin client system is described.

17. A program for a client terminal controlling, using a thin client system comprising the client terminal and a server apparatus, an application execution system between the client terminal and the server apparatus according to policy information in which application execution policy for executing application which is started up on the thin client system is described.

18. A program for a server apparatus controlling, using a thin client system comprising a client terminal and the server apparatus, an application execution system between the client terminal and the server apparatus according to policy information in which application execution policy for executing application which is started up on the thin client system is described.
